(19) United States
(12) Patent Application Publication
(10) Pub. No.: US 2017/0198404 A1
(43) Pub. Date: Jul. 13, 2017

(54) Ion-conducting membrane used in chlor-alkali industry and preparation method thereof

(71) Applicant: SHANDONG DONGYUE POLYMER MATERIAL CO., LTD., Zibo,Shandong (CN)

(72) Inventors: Jing Wang, Zibo,Shandong (CN); Yongming Zhang, Zibo,Shandong (CN); Miaokun Yang, Zibo,Shandong (CN); Heng Zhang, Zibo,Shandong (CN)

(73) Assignee: SHANDONG DONGYE POLYMER MATERIAL CO., LTD., Zibo, Shandong (CN)

(21) Appl. No.: 15/314,927

(22) PCT Filed: Jul. 7, 2014
(86) PCT No.: PCT/CN2014/000653

§ 371 Date: Nov. 29, 2016

(30) Foreign Application Priority Data
Jun. 6, 2014 (CN) 201410251263.X

(51) Int. Cl. C25B 13/08; B01D 69/02; C25B 13/02; B01D 71/40; B01D 67/00; C25B 1/46; B01D 69/10

(52) U.S. Cl. CPC C25B 13/08; C25B 1/46; B01D 69/02; B01D 69/10; B01D 71/40; B01D 67/0009; C25B 13/02; B01D 2325/42; B01D 2323/46

(57) ABSTRACT

An ion-conducting membrane used in the chlor-alkali industry and a preparation method thereof are disclosed. The ion-conducting membrane includes a perfluorinated ion exchange resin base film, a porous reinforcing material and a perfluorinated ion exchange resin micro-particle surface layer. The perfluorinated ion exchange resin micro-particles are a mixture of one or two of perfluorocarboxylic acid resin micro-particles and perfluorosulfonic acid carboxylic acid copolymer resin micro-particles with perfluorosulfonic acid resin micro-particles. A mass percentage of perfluorosulfonic acid resin micro-particles in the mixture is 50-95%. The surface layer of the present invention has good compatibility and adhesion, and maintains a good degassing effect during the entire lifespan of the ion-conducting membrane. The present invention is used in the chlor-alkali industry, stably and effectively processes alkali metal chloride solutions having a wide range concentration and suitable for operating in a zero polar distance electrolytic cell under novel high current density conditions.

### CROSS REFERENCE OF RELATED APPLICATION

This is a U.S. National Stage under 35 U.S. 371 of the International Application PCT/CN2014/000653, filed Jul. 7, 2014, which claims priority under 35 U.S.C. 119(a-d) to CN 201410251263.X, filed Jun. 6, 2014.

### BACKGROUND OF THE PRESENT INVENTION

Field of Invention

The present invention relates to a technical field of ionic membranes, and more particularly to an ion-conducting membrane used in chlor-alkali industry and a preparation method thereof.

Description of Related Arts

In recent years, during the ion-exchange membrane chlor-alkali production, in order to achieve electrolysis under high current density, low cell voltage and high lye concentration for improving productivity and reducing power consumption, the key is to shorten the distance between the ion-exchange membrane and the electrode for reducing the cell voltage thereof, thereby achieving the practicality of the narrow polar distance type ion-exchange membrane electrolysis process. With the continuous progress of technology, the zero polar distance electrolytic cell has been widely applied, and however, when the distance between the electrodes is reduced to be less than 2 mm, due to tightly attachment between the membrane and the negative electrode, hydrogen bubbles attached to the membrane surface are hard to be released, thus a large amount of hydrogen bubbles are accumulated on the membrane surface which faces to the negative electrode. The bubbles block the current channel for reducing the effective electrolytic area of the membrane, which results in unevenly current distribution on the membrane surface, thus the local polarization is obviously increased. Therefore, the membrane resistance and the cell voltage are sharply increased, and the electrolysis power consumption is significantly improved.

To overcome the shortcomings caused by the bubble effect, and rapidly release the attached hydrogen bubbles from the membrane surface with small hydrophilicity, a modification method of a hydrophilic coating on the ion-exchange membrane surface is developed. After coating a multi-porous non-electrocatalytic activity non-electrode coating, through which gases and liquids are able to permeate, on the membrane surface, the hydrophilicity of the membrane surface is obviously increased, the anti-foaming ability are significantly improved. The ion exchange membrane with the modified hydrophilic coating is able to be tightly attached to the electrode, so as to greatly reduce the cell voltage. Currently, it is widely applied to the zero polar distance type ion exchange membrane electrolysis process. The hydrophilic coating modification process includes steps of mixing inorganic components with special adhesives, and then coating on the ion exchange membrane surface through an electrolytic deposition method or a particle embedding method. Patent applications CA2446448 and CA2444585 specifically introduced the coating process. However, the above modification method has significant effect, but relatively complex process. Moreover, during the electrolysis operation, because the ion exchange membrane is continuously scoured by the lye flow and goes through the continuous shock caused by the turbulence, the hydrophilic coating attached to the ion exchange membrane surface gradually falls off, thus the anti-foaming function is gradually reduced to be of no effect.

Patent application U.S. Pat. No. 4,502,931 proposed to process the ion exchange membrane surface with surface roughening modification through an ion etching method. However, the method is not easy to be implemented on a large scale, and has low anti-foaming ability. When the distance between electrodes is reduced to a certain degree, the cell voltage is still larger than 3.5 V, and the current efficiency is lower than 90%.

Therefore, it is very important to develop a new ion-conducting membrane used in chlor-alkali industry, whose surface has long-term effective hydrophilic degassing function; and during the advanced electrolytic cell and electrolysis process, which is able to continuously provide the excellent anti-foaming effect, reduce the cell voltage, improve the current efficiency and reduce the power consumption.

### SUMMARY OF THE PRESENT INVENTION

In view of deficiencies in the prior art, an object of the present invention is to provide an ion-conducting membrane used in chlor-alkali industry, which is adapted for chlor-alkali industry, so as to stably and highly-effective process the alkali metal chloride solution with wide range concentration, is suitable for operating in a zero polar distance electrolytic cell under a condition of newly high current density, and has a very excellent product impurity index. Furthermore, the present invention also provides a preparation method of the ion-conducting membrane, which is simple and reasonable in process and facilitates the industrial production.

The ion-conducting membrane used in chlor-alkali industry, provided by the present invention, comprises a perfluorinated ion exchange resin base film, a porous reinforcing material and a perfluorinated ion exchange resin micro-particle surface layer.

In which, the perfluorinated ion exchange resin base film comprises a resin layer mainly made of perfluorosulfonic acid resin with a thickness of 30-300 μm, preferably, 50-150 μm, wherein: the resin layer mainly made of perfluorosulfonic acid resin is lower in fixed ion content and weak in repulsion to hydroxyl, and is not too thin in thickness; and a resin layer mainly made of perfluorocarboxylic acid resin with a thickness of 2-30 μm, preferably, 7-18 μm, wherein: the resin layer mainly made of perfluorocarboxylic acid resin is larger in membrane resistance and is not too large in thickness.

The resin layer mainly made of perfluorosulfonic acid resin is formed by blending or copolymerizing the perfluorosulfonic acid resin and perfluorocarboxylic acid resin with a mass ratio in a range of 100:0.1-100:10; and preferably, 100:0.5-100:5. The perfluorocarboxylic acid resin is minor presence in the resin layer mainly made of perfluorosulfonic acid resin, but is able to play a key role in transition, so as to weaken a permeation of water and ions in the membrane in a gradient manner; is able to play a role in stabilizing a flux of the ion exchange membrane; and simultaneously, is able to avoid peeling among different membrane layers.

The resin layer mainly made of perfluorocarboxylic acid resin is formed by blending or copolymerizing the perfluorocarboxylic acid resin and perfluorosulfonic acid resin with a mass ratio in a range of 100:0.1-100:10; and preferably, 100:0.5-100:5. The perfluorosulfonic acid resin is minor presence in the resin layer mainly made of perfluorocarboxylic acid resin, and is also able to play a key transition described in the above paragraph.

An exchange capacity of the perfluorosulfonic acid resin is 0.8-1.5 mmol/g, and preferably, 0.9-1.1 mmol/g; an exchange capacity of the perfluorocarboxylic acid resin is 0.8-1.2 mmol/g, and preferably, 0.85-1.0 mmol/g. The exchange capacity of the perfluorosulfonic acid resin matches with that of the perfluorocarboxylic acid resin, and a too large difference therebetween is not suitable.

A thickness of the perfluorinated ion exchange resin micro-particle surface layer is 20 nm-100 μm, and preferably, 50 nm-1 μm.

The perfluorinated ion exchange resin micro-particle is a mixture of one or two of perfluorocarboxylic acid resin micro-particle and perfluorosulfonic acid carboxylic acid copolymer resin micro-particle with perfluorosulfonic acid resin micro-particle; wherein: a weight percentage of the perfluorosulfonic acid resin micro-particle in the mixture is 50-95%; due to a hydrophilicity difference between the perfluorocarboxylic acid resin micro-particle or perfluorosulfonic acid carboxylic acid copolymer resin micro-particle and the perfluorosulfonic acid resin micro-particle, an appropriate introduction is able to optimize an accumulation morphology of the particles on the membrane surface, for reducing an agglomeration ratio of homogeneous particles. The perfluorinated ion exchange resin micro-particle surface layer are the perfluorinated ion exchange resin micro-particles which are obtained by crushing resin pellets for once in a low-temperature crushing device and then grinding in a cryogenic system. A particle size of the micro-particles is in a range of 20 nm-10 μm, and preferably, 50 nm-300 nm. When the particle size is too low, the particles are easily reunited to block the ion channels;

when the particle size is too high, the micro-particles formed on the membrane surface obviously protrudes from the membrane surface, so that they are easy to be detached from the membrane surface under external scratches. The ion exchange capacity of the perfluorinated ion exchange resin micro-particles is in a range of 0.01-1.5 mmol/g, and preferably, 0.3-1.0 mmol/g. When the ion exchange capability is too high, the perfluorinated ion exchange resin micro-particles in a water alcohol solution have a certain swelling degree, so that the own irregular morphology of the broken micro-particles is destroyed; and a volume of the broken micro-particles is expanded, such that a porosity is seriously reduced and ion channels are blocked; the broken micro-particles are not easily broken. When the ion exchange capability is too low, the ion permeability of the membrane is affected to a certain degree.

The porous reinforcing material is polytetrafluoroethylene non-woven fabric whose fiber junctions are lapped or fused together. A thickness of the porous reinforcing material is in a range of 1-200 μm, and preferably, 10-50 μm. The porous reinforcing material is able to improve mechanical strength and be prepared by prior arts. A porosity of the polytetrafluoroethylene non-woven fabric is in a range of 20-99%, and preferably, 50-85%. If the porosity is too low, a cell voltage will be increased.

A preparation method of the ion-conducting membrane used in chlor-alkali industry, provided by the present invention, comprises steps of:

(1) through a screw extruder, in a co-extrusion manner, melting and casting, forming a perfluorinated ion exchange resin base film, immersing a porous reinforcing material into a fluorocarbon solvent, ultrasonically processing the porous reinforcing material for 1-2 hours, taking out and drying the ultrasonically-processed porous reinforcing material, compounding the dried porous reinforcing material with the perfluorinated ion exchange resin base film, introducing the porous reinforcing material between two membrane forming rollers, pressing the porous reinforcing material into the perfluorinated ion exchange resin base film under an action of a pressure between the rollers, and forming a perfluorinated ion exchange membrane precursor;

(2) converting the perfluorinated ion exchange membrane precursor into an perfluorinated ion exchange membrane with ion exchange function;

(3) preparing a mixed solution by mixing water and ethanol with a weight ratio of 1:1, adding perfluorinated ion exchange resin micro-particles into the mixed solution, and then homogenizing in a ball mill, and forming a perfluorinated ion exchange resin micro-particle dispersion liquid; and

(4) attaching the perfluorinated ion exchange resin micro-particle dispersion liquid obtained in the step (3) to a surface of the perfluorinated ion exchange membrane obtained in the step (2), and forming a product after drying.

Wherein, in the step (1), the porous reinforcing material is immersed into the fluorocarbon solvent and ultrasonically processed for 1-2 hours, and then is compounded with the perfluorinated ion exchange resin base film after being taken out and dried. Because the immersion of the polytetrafluoroethylene non-woven fabric is very difficult, if the polytetrafluoroethylene non-woven fabric is directly compounded with the base film without being processed, resin matrixes are unable to completely fill voids of the non-woven fabric, so that an uncompacted space is formed within a membrane body, thus it is easy to not only deposit impurities, but also form a space barrier to increase resistance. After immersing the porous reinforcing material in the fluorocarbon solvent for 1-2 hours, an infiltration of the resin matrixes is very easy, the two are able to form an excellent and tight combination, which not only improves the mechanical strength, but minimally impacts on the membrane resistance due to high open porosity of the non-woven fabric.

In the step (1), the fluorocarbon solvent is trifluorotrichloroethane (F-113) or a mixture of the trifluorotrichloroethane with another solvent, wherein: the other solvent is one or more members selected from a group consisting of anhydrous ethanol, propanol, methanol, acetone, dichloromethane and a surfactant aqueous solution; the surfactant is an anionic, cationic, amphoteric or non-ionic surfactant on market.

The step (2) comprises: ultrasonically processing the perfluorinated ion exchange membrane precursor through an overpressure machine at 10-200° C. under a pressure of 20-100 tons with a speed of 1-50 m/min, and then immersing the perfluorinated ion exchange membrane precursor into a mixed aqueous solution comprising 15 wt % dimethyl sulfoxide and 20 wt % NaOH by weight, and forming the perfluorinated ion exchange membrane with ion exchange function; wherein: the ultrasonic process further increased a combination density of the non-woven fabric and the base film, and simultaneously, and improves a physical structure form of the non-woven fabric and the base film to a certain degree, a microfibrillarization of the non-woven fabric and a hot pressing of the base film lead to crystal structural refinement, which effectively improves an ion transfer effect.

In the step (3), the perfluorinated ion exchange resin micro-particles are obtained by crushing the resin pellets for once in the low-temperature crushing device and then grinding in the cryogenic system. The obtained perfluorinated ion exchange resin micro-particles have the irregular surface topography, which has excellent effect on desorption of surface layer foaming.

In the step (4), the perfluorinated ion exchange resin micro-particle dispersion liquid is attached to the surface of the perfluorinated ion exchange membrane obtained in the step (2), wherein: an attachment method comprises spray coating, brush coating, roll coating, dipping, transferring and spin coating, and preferably, is spray coating and roll coating. The process operation is preformed according to prior arts.

All in all, the present invention has advantages as follows.

(1) The inorganic oxide coating in prior arts is replaced by the perfluorinated ion exchange resin micro-particle surface layer in the present invention. Due to the same chemical structure with the base film, the perfluorinated ion exchange resin micro-particles has excellent compatibility and adhesion, thus it is ensured that the ion-conducting membrane used in chlor-alkali industry maintains excellent degassing effect during the whole life, and the degassing effect of the ion-conducting membrane provided by the present invention is better than that of the inorganic oxide coating.

(2) The perfluorinated ion exchange resin micro-particle surface layer are the perfluorinated ion exchange resin micro-particles. The perfluorinated ion exchange resin micro-particles are a mixture of one or two of perfluorocarboxylic acid resin micro-particles and perfluorosulfonic acid carboxylic acid copolymer resin micro-particles with perfluorosulfonic acid resin micro-particles; due to the hydrophilicity difference between the perfluorocarboxylic acid resin micro-particles or the perfluorosulfonic acid carboxylic acid copolymer resin micro-particles and the perfluorosulfonic acid resin micro-particles, the appropriate introduction is able to optimize the accumulation morphology of the particles on the membrane surface, for reducing the agglomeration ratio of the homogeneous particles.

(3) The perfluorinated ion exchange resin micro-particle surface layer has the ion exchange function, which is beneficial to reducing the cell voltage and the surface resistance of the ion-conducting membrane.

(4) The polytetrafluoroethylene non-woven fabric is compounded with the base film after solvent processing, and the overpressure process is adopted, so that while obtaining excellent electrochemical performance and mechanical performance, the anti-impurity property of the ion-conducting membrane is greatly improved.

(5) The present invention provides an ion-conducting membrane which is adapted for electrolyzing NaCl/KCl to prepare chlorine gas and NaOH/KOH. The introduction of the polytetrafluoroethylene non-woven fabric improves the purity of the product, the purity of the electrolyzed chlorine gas is larger than and equal to 99.5%, that of the hydrogen gas is larger than and equal to 99.9%, and the content of salt in alkali is smaller than and equal to 5 ppm.

(6) The ion-conducting membrane provided by the present invention is adapted for electrolyzing the alkali with the concentration of 30-35%, and however, the ion-conducting membrane in prior arts is generally adapted for electrolyzing the alkali with the concentration of 30-32%.

(7) The ion-conducting membrane used in chlor-alkali industry provided by the present invention is able to stably and highly-effective process the alkali metal chloride solution with the wide range concentration, which is adapted for operating the zero polar electrolyzing cell under the condition of new high current density. While improving the purity of the product, the cell voltage is significantly reduced. Under the current density higher than 5.5 KA/m², the cell voltage is lower than 2.75 V.

(8) The present invention also provides a preparation method of the ion-conducting membrane used in chlor-alkali industry which has simple and reasonable process, and facilitates the industrial production.

### DETAILED DESCRIPTION OF THE PREFERRED EMBODIMENT

The present invention is further explained with accompanying embodiments in detail.

### EXAMPLE 1

(1) Select perfluorosulfonic acid resin with IEC=1.05 mmol/g and perfluorocarboxylic acid resin with IEC=1.0 mmol/g; form a perfluorinated ion exchange resin base film in a co-extrusion and cast manner, wherein: in a resin layer mainly made of perfluorosulfonic acid resin, a weight ratio of the perfluorosulfonic acid resin to perfluorocarboxylic acid resin is 100:1; in a resin layer mainly made of the perfluorocarboxylic acid resin, a weight ratio of the perfluorocarboxylic acid resin to the perfluorosulfonic acid resin is 100:1; the resin layer mainly made of perfluorosulfonic acid resin has a thickness of 120 μm, and resin layer mainly made of the perfluorocarboxylic acid resin has a thickness of 10 μm; and then immerse a porous reinforcing material polytetrafluoroethylene non-woven fabric in trifluoro-trichloroethane solvent in an ultrasound processor for 1.5 hours, wherein: a thickness of the non-woven fabric is 40 μm, a porosity is 75%; take out and dry the non-woven fabric; and then compound with the perfluorinated ion exchange resin base film; introduce a porous reinforcing material between two membrane forming rollers, press the porous reinforcing material into a membrane body under a pressure between the rollers, and form a perfluorinated ion exchange membrane precursor.

(2) Ultrasonically process the perfluorinated ion exchange membrane precursor obtained in the step (1) through an overpressure machine at 180° C. under a pressure of 80 tons with a speed of 40 m/min, and then immerse the perfluorinated ion exchange membrane precursor into a mixed aqueous solution comprising 15 wt % dimethyl sulfoxide and 20 wt % NaOH by weight at 85° C. for 80 minutes, and form a perfluorinated ion exchange membrane with ion exchange function.

(3) Prepare a mixed solution by mixing water and ethanol with a weight ratio of 1:1; add perfluorinated ion exchange resin micro-particles (which are obtained by crushing resin pellets for once in a low-temperature crushing device and then grinding in a cryogenic system) with IEC=0.85 mmol/g, an average particle size of 60 nm, and irregular polygon topography, into the mixed solution; and then homogenize in a ball mill, and form a dispersion liquid with a content of 15 wt %, wherein: the perfluorinated ion exchange resin micro-particles are a mixture of the perfluorosulfonic acid resin micro-particles and the perfluorocarboxylic acid resin micro-particles; a weight percentage of the perfluorosulfonic acid resin micro-particles in the mixture is 50%.

(4) Attach the dispersion liquid to a surface of two sides of the perfluorinated ion exchange membrane obtained in the step (2), wherein: a thickness of the surface layer is 200 nm; and form a product after drying.

Performance Testing:

An electrolytic test of the prepared ion exchange membrane about NaCl aqueous solution in an electrolysis cell is performed. 300 g/L NaCl aqueous solution is supplied to an anode chamber, water is supplied to a cathode chamber, it is ensured that a concentration of NaCl discharged from the anode chamber is 200 g/L, and a concentration of NaOH discharged from the cathode chamber is 34%; a test temperature is 90° C., a current density is 7.5 kA/m²; after 23 days of electrolysis experiments, the average cell voltage is 2.74 V and the average current efficiency is 99.4%.

Afterwards, 15 ppb inorganic matter Ca and Mg impurity are added to the NaCl aqueous solution; under the same conditions, after 40 days of electrolysis experiments, the average cell voltage is 2.75 V and the average current efficiency is 99.4%.

Based on standard SJ/T 10171.5, a surface resistance of the obtained membrane is tested to be 1.1 Ω·cm⁻²; based on ASTM Standard D 1044-99, a wear loss of the obtained membrane is tested to be 2.7 mg.

According to electrolytic product testing standards, a purity of the electrolytic product is as follows. A purity of chlorine gas is 99.4%, that of hydrogen gas is 99.8% and a content of salt in alkali is 4 ppm.

### Comparative Example 1

A same method as the example 1 is adopted to prepare the ion exchange membrane with ion exchange function; afterwards, a same method is adopted to prepare the dispersion liquid. Differences between the example 1 and the comparative example 1 are as follows. The perfluorinated ion exchange resin micro-particles in the dispersion liquid are replaced by inorganic oxide particles with an average particle size of 60 nm, and then homogenized in the ball mill, and the dispersion liquid with a content of 15 wt % is formed. The same method is adopted to obtain the ion exchange membrane attached with the inorganic oxide coating at two sides thereof.

Under the same conditions as the example 1, the electrolytic test of NaCl aqueous solution is performed. After 23 days of electrolysis experiments, the average cell voltage is 2.91 V, the average current efficiency is 96.1%, the surface resistance is 2.4 Ω·cm⁻², and the wear loss is 11 mg.

### Comparative Example 2

A same method as the example 1 is adopted to prepare an ion exchange membrane with ion exchange function. Differences are as follows. Before compounding with the perfluorinated ion exchange resin base film, the porous reinforcing material is not immersed into the fluorocarbon solvent, and after compounding with perfluorinated ion exchange resin base film, the porous reinforcing material is not processed through the overpressure machine. The perfluorinated ion exchange resin micro-particle dispersion liquid is prepared by a same method as the example 1, and then homogenized in a ball mill, and a dispersion liquid with a content of 15 wt % is formed. A same operation as the example 1 is performed to obtain an ion exchange membrane product.

Under the same conditions as the example 1, the electrolytic test of NaCl aqueous solution is performed. After 23 days of electrolysis experiments, the average cell voltage is 2.84 V, the average current efficiency is 99.1%, and the surface resistance is 1.7 Ω·cm⁻². Afterwards, 15 ppb inorganic matter Ca and Mg impurity are added to the NaCl aqueous solution; under the same conditions, after 40 days of electrolysis experiments, the average cell voltage is 2.94 V and the average current efficiency is 97.4%. A purity of the electrolytic product is as follows. A purity of chlorine gas is 98.5%, that of hydrogen gas is 98.6% and a content of salt in alkali is 16 ppm.

### EXAMPLE 2

(1) Select perfluorosulfonic acid resin with IEC=1.1 mmol/g and perfluorocarboxylic acid resin with IEC=0.95 mmol/g; form a perfluorinated ion exchange resin base film in a co-extrusion and cast manner, wherein: in a resin layer mainly made of perfluorosulfonic acid resin, a weight ratio of the perfluorosulfonic acid resin to perfluorocarboxylic acid resin is 100:0.5; in a resin layer mainly made of the perfluorocarboxylic acid resin, a weight ratio of the perfluorocarboxylic acid resin to the to perfluorosulfonic acid resin is 100:0.5; the resin layer mainly made of perfluorosulfonic acid resin has a thickness of 100 μm, and resin layer mainly made of the perfluorocarboxylic acid resin has a thickness of 15 μm; and then immerse a porous reinforcing material polytetrafluoroethylene non-woven fabric in a mixed solvent of trifluoro-trichloroethane and anhydrous ethanol in an ultrasound processor for 1 hour, wherein: a thickness of the non-woven fabric is 30 μm, a porosity is 65%; take out and dry the non-woven fabric; and then compound with the perfluorinated ion exchange resin base film; introduce a porous reinforcing material between two membrane forming rollers, press the porous reinforcing material into a membrane body under a pressure between the rollers, and form a perfluorinated ion exchange membrane precursor.

(2) Ultrasonically process the perfluorinated ion exchange membrane precursor obtained in the step (1) through an overpressure machine at 160° C. under a pressure of 100 tons with a speed of 40 m/min, and then immerse the perfluorinated ion exchange membrane precursor into a mixed aqueous solution comprising 15 wt % dimethyl sulfoxide and 20 wt % NaOH by weight at 85° C. for 80 minutes, and form a perfluorinated ion exchange membrane with ion exchange function.

(3) Prepare a mixed solution by mixing water and ethanol with a weight ratio of 1:1; add perfluorinated ion exchange resin micro-particles (which are obtained by crushing resin pellets for once in a low-temperature crushing device and then grinding in a cryogenic system) with IEC=1.0 mmol/g, an average particle size of 50 nm, and irregular polygon topography, into the mixed solution; and then homogenize in a ball mill, and form a dispersion liquid with a content of 15 wt %, wherein: the perfluorinated ion exchange resin micro-particles are a mixture of the perfluorosulfonic acid resin micro-particles, perfluorosulfonic acid carboxylic acid copolymer resin micro-particles and the perfluorocarboxylic acid resin micro-particles; a weight percentage of the perfluorosulfonic acid resin micro-particles in the mixture is 75%.

(4) Attach the dispersion liquid to a surface of two sides of the perfluorinated ion exchange membrane obtained in the step (2), wherein: a thickness of the surface layer is 50 nm; and form a product after drying.

Performance Testing:

An electrolytic test of the prepared ion exchange membrane about NaCl aqueous solution in an electrolysis cell is performed. 300 g/L NaCl aqueous solution is supplied to an anode chamber, water is supplied to a cathode chamber, it is ensured that a concentration of NaCl discharged from the anode chamber is 200 g/L, and a concentration of NaOH discharged from the cathode chamber is 35%; a test temperature is 90° C., a current density is 6.5 kA/m²; after 23 days of electrolysis experiments, the average cell voltage is 2.73 V and the average current efficiency is 99.6%.

Afterwards, 15 ppb inorganic matter Ca and Mg impurity are added to the NaCl aqueous solution; under the same conditions, after 40 days of electrolysis experiments, the average cell voltage is 2.73 V and the average current efficiency is 99.7%.

Based on standard SJ/T 10171.5, a surface resistance of the obtained membrane is tested to be 1.0 Ω·cm⁻²; based on ASTM Standard D 1044-99, a wear loss of the obtained membrane is tested to be 2.8 mg.

According to electrolytic product testing standards, a purity of the electrolytic product is as follows. A purity of chlorine gas is 99.5%, that of hydrogen gas is 99.9% and a content of salt in alkali is 3 ppm.

### EXAMPLE 3

(1) Select perfluorosulfonic acid resin with IEC=1.0 mmol/g and perfluorocarboxylic acid resin with IEC=0.9 mmol/g; form a perfluorinated ion exchange resin base film in a co-extrusion and cast manner, wherein: in a resin layer mainly made of perfluorosulfonic acid resin, a weight ratio of the perfluorosulfonic acid resin to perfluorocarboxylic acid resin is 100:3; in a resin layer mainly made of the perfluorocarboxylic acid resin, a weight ratio of the perfluorocarboxylic acid resin to the perfluorosulfonic acid resin is 100:2.5; the resin layer mainly made of perfluorosulfonic acid resin has a thickness of 150 μm, and resin layer mainly made of the perfluorocarboxylic acid resin has a thickness of 7 μm; and then immerse a porous reinforcing material polytetrafluoroethylene non-woven fabric in a mixed solvent of trifluoro-trichloroethane and propanol in an ultrasound processor for 1 hour, wherein: a thickness of the non-woven fabric is 10 μm, a porosity is 50%; take out and dry the non-woven fabric; and then compound with the perfluorinated ion exchange resin base film; introduce a porous reinforcing material between two membrane forming rollers, press the porous reinforcing material into a membrane body under a pressure between the rollers, and form a perfluorinated ion exchange membrane precursor.

(2) Ultrasonically process the perfluorinated ion exchange membrane precursor obtained in the step (1) through an overpressure machine at 100° C. under a pressure of 20 tons with a speed of 10 m/min, and then immerse the perfluorinated ion exchange membrane precursor into a mixed aqueous solution comprising 15 wt % dimethyl sulfoxide and 20 wt % NaOH by weight at 85° C. for 80 minutes, and form a perfluorinated ion exchange membrane with ion exchange function.

(3) Prepare a mixed solution by mixing water and ethanol with a weight ratio of 1:1; add perfluorinated ion exchange resin micro-particles (which are obtained by crushing resin pellets for once in a low-temperature crushing device and then grinding in a cryogenic system) with IEC=0.8 mmol/g, an average particle size of 100 nm, and irregular polygon topography, into the mixed solution; and then homogenize in a ball mill, and form a dispersion liquid with a content of 15 wt %, wherein: the perfluorinated ion exchange resin micro-particles are a mixture of the perfluorosulfonic acid resin micro-particles, and perfluorosulfonic acid carboxylic acid copolymer resin micro-particles; a weight percentage of the perfluorosulfonic acid resin micro-particles in the mixture is 65%.

(4) Attach the dispersion liquid to a surface of two sides of the perfluorinated ion exchange membrane obtained in the step (2), wherein: a thickness of the surface layer is 400 nm; and form a product after drying.

Performance Testing:

An electrolytic test of the prepared ion exchange membrane about NaCl aqueous solution in an electrolysis cell is performed. 300 g/L NaCl aqueous solution is supplied to an anode chamber, water is supplied to a cathode chamber, it is ensured that a concentration of NaCl discharged from the anode chamber is 200 g/L, and a concentration of NaOH discharged from the cathode chamber is 32%; a test temperature is 90° C., a current density is 7.5 kA/m²; after 23 days of electrolysis experiments, the average cell voltage is 2.75 V and the average current efficiency is 99.7%.

Afterwards, 15 ppb inorganic matter Ca and Mg impurity are added to the NaCl aqueous solution; under the same conditions, after 40 days of electrolysis experiments, the average cell voltage is 2.75 V and the average current efficiency is 99.7%.

Based on standard SJ/T 10171.5, a surface resistance of the obtained membrane is tested to be 1.2 Ω·cm⁻²; based on ASTM Standard D 1044-99, a wear loss of the obtained membrane is tested to be 2.7 mg.

According to electrolytic product testing standards, a purity of the electrolytic product is as follows. A purity of chlorine gas is 99.8%, that of hydrogen gas is 99.8% and a content of salt in alkali is 4 ppm.

### EXAMPLE 4

(1) Select perfluorosulfonic acid resin with IEC=0.9 mmol/g and perfluorocarboxylic acid resin with IEC=0.85 mmol/g; form a perfluorinated ion exchange resin base film in a co-extrusion and cast manner, wherein: in a resin layer mainly made of perfluorosulfonic acid resin, a weight ratio of the perfluorosulfonic acid resin to perfluorocarboxylic acid resin is 100:5; in a resin layer mainly made of the perfluorocarboxylic acid resin, a weight ratio of the perfluorocarboxylic acid resin to the perfluorosulfonic acid resin is 100:4; the resin layer mainly made of perfluorosulfonic acid resin has a thickness of 75 μm, and resin layer mainly made of the perfluorocarboxylic acid resin has a thickness of 18 μm; and then immerse a porous reinforcing material polytetrafluoroethylene non-woven fabric in a mixed solvent of trifluorotrichloroethane and methanol in an ultrasound processor for 1.5 hours, wherein: a thickness of the non-woven fabric is 50 μm, a porosity is 65%; take out and dry the non-woven fabric; and then compound with the perfluorinated ion exchange resin base film; introduce a porous reinforcing material between two membrane forming rollers, press the porous reinforcing material into a membrane body under a pressure between the rollers, and form a perfluorinated ion exchange membrane precursor.

(2) Ultrasonically process the perfluorinated ion exchange membrane precursor obtained in the step (1) through an overpressure machine at 200° C. under a pressure of 40 tons with a speed of 10 m/min, and then immerse the perfluorinated ion exchange membrane precursor into a mixed aqueous solution comprising 15 wt % dimethyl sulfoxide and 20 wt % NaOH by weight at 85° C. for 80 minutes, and form a perfluorinated ion exchange membrane with ion exchange function.

(3) Prepare a mixed solution by mixing water and ethanol with a weight ratio of 1:1; add perfluorinated ion exchange resin micro-particles (which are obtained by crushing resin pellets for once in a low-temperature crushing device and then grinding in a cryogenic system) with IEC=0.5 mmol/g, an average particle size of 200 nm, and irregular polygon topography, into the mixed solution; and then homogenize in a ball mill, and form a dispersion liquid with a content of 15 wt %, wherein: the perfluorinated ion exchange resin micro-particles are a mixture of the perfluorosulfonic acid resin micro-particles, and the perfluorocarboxylic acid resin micro-particles; a weight percentage of the perfluorosulfonic acid resin micro-particles in the mixture is 80%.

(4) Attach the dispersion liquid to a surface of two sides of the perfluorinated ion exchange membrane obtained in the step (2), wherein: a thickness of the surface layer is 700 nm; and form a product after drying.

Performance Testing:

An electrolytic test of the prepared ion exchange membrane about NaCl aqueous solution in an electrolysis cell is performed. 300 g/L NaCl aqueous solution is supplied to an anode chamber, water is supplied to a cathode chamber, it is ensured that a concentration of NaCl discharged from the anode chamber is 200 g/L, and a concentration of NaOH discharged from the cathode chamber is 30%; a test temperature is 90° C., a current density is 6.5 kA/m²; after 23 days of electrolysis experiments, the average cell voltage is 2.71 V and the average current efficiency is 99.8%.

Afterwards, 15 ppb inorganic matter Ca and Mg impurity are added to the NaCl aqueous solution; under the same conditions, after 40 days of electrolysis experiments, the average cell voltage is 2.71 V and the average current efficiency is 99.8%.

Based on standard SJ/T 10171.5, a surface resistance of the obtained membrane is tested to be 1.3 Ω·cm⁻²; based on ASTM Standard D 1044-99, a wear loss of the obtained membrane is tested to be 2.8 mg.

According to electrolytic product testing standards, a purity of the electrolytic product is as follows. A purity of chlorine gas is 99.8%, that of hydrogen gas is 100% and a content of salt in alkali is 4 ppm.

### EXAMPLE 5

(1) Select perfluorosulfonic acid resin with IEC=0.95 mmol/g and perfluorocarboxylic acid resin with IEC=0.85 mmol/g; form a perfluorinated ion exchange resin base film in a co-extrusion and cast manner, wherein: in a resin layer mainly made of perfluorosulfonic acid resin, a weight ratio of the perfluorosulfonic acid resin to perfluorocarboxylic acid resin is 100:3; in a resin layer mainly made of the perfluorocarboxylic acid resin, a weight ratio of the perfluorocarboxylic acid resin to the perfluorosulfonic acid resin is 100:5; the resin layer mainly made of perfluorosulfonic acid resin has a thickness of 50 μm, and resin layer mainly made of the perfluorocarboxylic acid resin has a thickness of 10 μm; and then immerse a porous reinforcing material polytetrafluoroethylene non-woven fabric in a mixed solvent of trifluoro-trichloroethane and acetone in an ultrasound processor for 1 hour, wherein: a thickness of the non-woven fabric is 10 μm, a porosity is 85%; take out and dry the non-woven fabric; and then compound with the perfluorinated ion exchange resin base film; introduce a porous reinforcing material between two membrane forming rollers, press the porous reinforcing material into a membrane body under a pressure between the rollers, and form a perfluorinated ion exchange membrane precursor.

(2) Ultrasonically process the perfluorinated ion exchange membrane precursor obtained in the step (1) through an overpressure machine at 10° C. under a pressure of 60 tons with a speed of 1 m/min, and then immerse the perfluorinated ion exchange membrane precursor into a mixed aqueous solution comprising 15 wt % dimethyl sulfoxide and 20 wt % NaOH by weight at 85° C. for 80 minutes, and form a perfluorinated ion exchange membrane with ion exchange function.

(3) Prepare a mixed solution by mixing water and ethanol with a weight ratio of 1:1; add perfluorinated ion exchange resin micro-particles (which are obtained by crushing resin pellets for once in a low-temperature crushing device and then grinding in a cryogenic system) with IEC=0.3 mmol/g, an average particle size of 300 nm, and irregular polygon topography, into the mixed solution; and then homogenize in a ball mill, and form a dispersion liquid with a content of 15 wt %, wherein: the perfluorinated ion exchange resin micro-particles are a mixture of the perfluorosulfonic acid resin micro-particles, perfluorosulfonic acid carboxylic acid copolymer resin micro-particles and the perfluorocarboxylic acid resin micro-particles; a weight percentage of the perfluorosulfonic acid resin micro-particles in the mixture is 85%.

(4) Attach the dispersion liquid to a surface of two sides of the perfluorinated ion exchange membrane obtained in the step (2), wherein: a thickness of the surface layer is 1 μm; and form a product after drying.

Performance Testing:

An electrolytic test of the prepared ion exchange membrane about NaCl aqueous solution in an electrolysis cell is performed. 300 g/L NaCl aqueous solution is supplied to an anode chamber, water is supplied to a cathode chamber, it is ensured that a concentration of NaCl discharged from the anode chamber is 200 g/L, and a concentration of NaOH discharged from the cathode chamber is 34%; a test temperature is 90° C., a current density is 5.5 kA/m²; after 23 days of electrolysis experiments, the average cell voltage is 2.70 V and the average current efficiency is 99.8%.

Afterwards, 15 ppb inorganic matter Ca and Mg impurity are added to the NaCl aqueous solution; under the same conditions, after 40 days of electrolysis experiments, the average cell voltage is 2.71 V and the average current efficiency is 99.8%.

Based on standard SJ/T 10171.5, a surface resistance of the obtained membrane is tested to be 1.1 Ω·cm⁻²; based on ASTM Standard D 1044-99, a wear loss of the obtained membrane is tested to be 2.8 mg.

According to electrolytic product testing standards, a purity of the electrolytic product is as follows. A purity of chlorine gas is 99.8%, that of hydrogen gas is 99.8% and a content of salt in alkali is 3 ppm.

1. An ion-conducting membrane for chlor-alkali industry, comprising: a perfluorinated ion exchange resin base film, a porous reinforcing material and a perfluorinated ion exchange resin micro-particle surface layer.

2. The ion-conducting membrane for chlor-alkali industry, as recited in claim 1, wherein: the perfluorinated ion exchange resin base film comprises a resin layer mainly made of perfluorosulfonic acid resin with a thickness of 30-300 μm and a resin layer mainly made of perfluorocarboxylic acid resin with a thickness of 2-30 μm.

3. The ion-conducting membrane for chlor-alkali industry, as recited in claim 2, wherein: the resin layer mainly made of perfluorosulfonic acid resin is formed by blending or copolymerizing the perfluorosulfonic acid resin and the perfluorocarboxylic acid resin with a mass ratio in a range of 100:0.1-100:10.

4. The ion-conducting membrane for chlor-alkali industry, as recited in claim 3, wherein: an exchange capacity of the perfluorosulfonic acid resin is 0.8-1.5 mmol/g, and an exchange capacity of the perfluorocarboxylic acid resin is 0.8-1.2 mmol/g.

5. The ion-conducting membrane for chlor-alkali industry, as recited in claim 1, wherein: a thickness of the perfluorinated ion exchange resin micro-particle surface layer is 20 nm-100 μm, the perfluorinated ion exchange resin micro-particle surface layer are perfluorosulfonic acid resin micro-particles with a particle size of 20 nm-10 μm, and an ion exchange capacity of the perfluorinated ion exchange resin micro-particles is in a range of 0.01-1.5 mmol/g.

6. The ion-conducting membrane for chlor-alkali industry, as recited in claim 1, wherein: the perfluorinated ion exchange resin micro-particles are a mixture of one or two of perfluorocarboxylic acid resin micro-particles and perfluorosulfonic acid carboxylic acid copolymer resin micro-particles with perfluorosulfonic acid resin micro-particles; wherein: a weight percentage of the perfluorosulfonic acid resin micro-particles in the mixture is 50-95%

7. The ion-conducting membrane for chlor-alkali industry, as recited in claim 1, wherein: the porous reinforcing material is polytetrafluoroethylene non-woven fabric whose fiber junctions are lapped or fused together, a thickness of the porous reinforcing material is in a range of 1-200 μm, and a porosity of the polytetrafluoroethylene non-woven fabric is in a range of 20-99%.

8. A preparation method of an ion-conducting membrane used in chlor-alkali industry comprising steps of:
(1) through a screw extruder, in a co-extrusion manner, melting and casting, forming a perfluorinated ion exchange resin base film, immersing a porous reinforcing material into a fluorocarbon solvent, ultrasonically processing the porous reinforcing material for 1-2 hours, taking out and drying the ultrasonically-processed porous reinforcing material, compounding the dried porous reinforcing material with the perfluorinated ion exchange resin base film, introducing the porous reinforcing material between two membrane forming rollers, pressing the porous reinforcing material into the perfluorinated ion exchange resin base film under an action of a pressure between the rollers, and forming a perfluorinated ion exchange membrane precursor;
(2) converting the perfluorinated ion exchange membrane precursor obtained in the step (1) into an perfluorinated ion exchange membrane with ion exchange function;
(3) preparing a mixed solution by mixing water and ethanol with a weight ratio of 1:1, adding perfluorinated ion exchange resin micro-particles into the mixed solution, and then homogenizing in a ball mill, and forming a perfluorinated ion exchange resin micro-particle dispersion liquid; and
(4) attaching the perfluorinated ion exchange resin micro-particle dispersion liquid obtained in the step (3) to a surface of the perfluorinated ion exchange membrane obtained in the step (2), and forming a product after drying.

9. The preparation method of the ion-conducting membrane used in chlor-alkali industry, as recited in claim 8, wherein:
the step (2) comprises: ultrasonically processing the perfluorinated ion exchange membrane precursor through an overpressure machine at 10-200° C. under a pressure of 20-100 tons with a speed of 1-50 m/min, and then immersing the perfluorinated ion exchange membrane precursor into a mixed aqueous solution comprising 15 wt % dimethyl sulfoxide and 20 wt % NaOH by weight, and forming the perfluorinated ion exchange membrane with ion exchange function.

10. The preparation method of the ion-conducting membrane used in chlor-alkali industry, as recited in claim 8, wherein:
in the step (3), the perfluorinated ion exchange resin micro-particles are obtained by crushing the resin pellets for once in the low-temperature crushing device and then grinding in the cryogenic system.
